(19) United States
(12) Patent Application Publication
(10) Pub. No.: US 2026/0276554 A1
(43) Pub. Date: Sep. 17, 2026

(54) Erosion Measurement System for Turbine Blade

(71) Applicants: KOREA ELECTRIC POWER CORPORATION, Naju-si (KR); KOREA SOUTH-EAST POWER CO., LTD., Jinju-si (KR); KOREA MIDLAND POWER CO., LTD., Boryeong-si (KR); KOREA WESTERN POWER CO., LTD., Taean-gun (KR); KOREA SOUTH POWER CO., LTD., Busan (KR); KOREA EAST-WEST POWER CO., LTD., Ulsan (KR)

(72) Inventors: Myung Soo PARK, Daejeon (KR); Bum Shin KIM, Daegu (KR); Dong Hwan KIM, Daejeon (KR); Jin Soo KIM, Seoul (KR); Chang Min LEE, Daejeon (KR)

(21) Appl. No.: 19/130,736

(22) PCT Filed: Aug. 11, 2023
(86) PCT No.: PCT/KR2023/012006

§ 371 Date: May 15, 2026

(30) Foreign Application Priority Data
Nov. 16, 2022 (KR) 10-2022-0153992

(51) Int. Cl. G01N 21/88; G06T 7/00

(52) U.S. Cl. CPC G01N 21/8806; G06T 7/0002; G01N 2201/103; G06T 2207/10152

(57) ABSTRACT

Disclosed is an erosion measurement system for a turbine blade, including: a light illumination device for irradiating light to generate a brightness difference to distinguish a measurement region when inspecting a turbine blade; an optical image acquisition device for creating an image optically photographing a blade surface; and an image analysis and erosion amount calculation device for analyzing an image photographed by the optical image acquisition device and calculating an erosion amount of a blade, and the light illumination device and the optical image acquisition device are fixed to face each other with a target blade disposed at a center and photographing a target blade while moving relatively in a circumferential direction of a turbine, and the image analysis and erosion amount calculation device may calculate an erosion amount in a manner accumulating an erosion amount at a plurality of measurement locations located inside a blade.

### TECHNICAL FIELD

The present disclosure relates to an erosion measurement system for a turbine blade through an optical image analysis, in particular, an erosion measurement system for a turbine blade which can be used for establishing an operation scenario for a target power plant based on a record of an erosion amount of a steam turbine blade, and predicting an erosion amount of a steam turbine blade based on the operation scenario.

### BACKGROUND ART

A turbine is a key device that plays a pivotal role in power generation by converting thermal energy into rotational energy among various devices operated in a power plant. Depending on a type and process conditions of a power plant, the turbine is in contact with steam or combustion gas corresponding to a temperature of 500° C. to as high as 1500° C., rotates at high speeds ranging from 1800 RPM to 3600 RPM depending on a model, and consists of multiple stages depending on a capacity. In particular, in the case of a first stage, erosion occurs due to high-speed collision with external inflows according to operating conditions of the power plant.

Turbine erosion, as mentioned above, is accelerated when steam or combustion gas, which is a working fluid of the turbine, collides with the turbine blades according to the operating conditions of the power plant. In other words, the erosion of blades is closely related to the operating conditions of the power plant along with a shape and material of the turbine. In particular, in the last stage of a turbine operated in a steam power plant, inflow steam is condensed and a phase change into water droplets having a relatively large mass occurs, and then moisture erosion occurs when the water droplets collide with the blades at high speed.

FIG. 1 are photos illustrating cases of damage to turbine blades caused by water droplet erosion.

Conventional technical methods for responding to turbine erosion are largely a method of applying a coating to a base material of a blade (application No. 10-2020-7015133), a method of applying a protective material which is additionally attaching a wear-resistant material to an outer surface of a blade (application No. 10-2015-7006689), and a method for predicting an erosion amount (JP1991-170043A), and the like. In the case of the method of applying a coating, it is necessary to periodically check the effectiveness of the coating and re-coat the base material to maintain the effect of the coating.

However, considering the characteristics of low-pressure turbine blades with complex shapes and the fact that there are more than 200 sets or more per power plant, the method has a limit that it is not easy to be applied. In addition, in the case of the method of applying the wear-resistant protective material to the outer surface of the blade, the welding protective material may be separated due to the acceleration of crevice corrosion due to the occurrence of heterogeneous welds, thereby causing secondary damage to an adjacent blade and diaphragm.

In the case of the method for predicting an erosion amount, most of the methods utilized a database of correlation between an amount of erosion and physical measurements that can be obtained from the blade, such as roughness of a blade surface. However, since this method re-estimates and monitors a current erosion amount of a turbine, it is impossible to predict erosion amount of a blade expected during future operation.

Conventional technologies for measuring the erosion amount occurring in turbine blades include a method of estimating the erosion amount based on the correlation between a change amount in a curvature of a distal end of a blade and a measured value of surface roughness, and the erosion amount, and the method of estimating the erosion amount after laser irradiation on a surface of the blade, and a method of calculating the erosion amount by irradiating laser to a blade surface and analyzing a reflection value in a form of coordinates. However, when measuring the erosion amount based on the above correlation, there is a problem in that it is difficult to apply it to turbines in which a material of a target blade is different or the operating conditions are different. In the case of the method of measuring by irradiating a laser, there is a limitation in that a plurality of laser transceivers are required for each location to be measured, or in the case of using a single laser, multiple operations are required.

In particular, due to the application limitations of the methods described above, operators are manually measuring the erosion amount by using general measurement tools such as vernier calipers. In the case of this manual measurement method, as shown in FIG. 1, since the blade damage caused by erosion takes the form of a sharp spike, there is room for a very large error depending on the operator's measurement location and posture, and this problem may cause the measurement to be repeated.

In addition, in recent years, there have been an increasing number of new renewable energy sources with high variability in power supply, such as solar power generation and wind power generation, being incorporated into the power supply system. In addition, the share of new renewable energy sources among all energy sources is expected to accelerate further in the future. Accordingly, the operation pattern of a large-capacity base load power plants, which have been continuously operated at 100% of rated output without significant change in an output load, is rapidly changing to patterns of Weekly Stop and Start, a partial load operation and the like.

Changes in the operating environment of these power generation facilities eventually lead to severe operating conditions in terms of erosion of turbine blades, which may soon cause an increase in moisture contained in the working fluid inside the turbine and consequently intensify water droplet erosion.

Therefore, considering the recent status of power supply systems where the amount of power generation by renewable energy sources is rapidly increasing and the manufacturing characteristics of blades that are production in a custom-made method and taking several months to several years from order to final arrival at the site, it is urgently required to secure the operational reliability of turbines, which are core facilities of power plants, through precise measurement of the erosion amount of turbine blades.

### DISCLOSURE

### Technical Problem

The present disclosure aims to provide an erosion measurement system for a turbine blade capable of precisely and quickly measuring the erosion amount of turbine blades so that the operational reliability of turbines of a power plant can be secured.

### Technical Solution

One embodiment is an erosion measurement system for a turbine blade, including: a light illumination device for irradiating light to generate a brightness difference to distinguish a measurement region when inspecting a turbine blade; an optical image acquisition device for creating an image optically photographing a blade surface; and an image analysis and erosion amount calculation device for analyzing an image photographed by the optical image acquisition device and calculating an erosion amount of a blade,

and the light illumination device and the optical image acquisition device are fixed to face each other with a target blade disposed at a center and photographing a target blade while moving relatively in a circumferential direction of a turbine, and the image analysis and erosion amount calculation device may calculate an erosion amount in a manner accumulating an erosion amount at a plurality of measurement locations located inside a blade.

Here, the erosion measurement system for a turbine blade may further include: a turbine rotation means for rotating a turbine in a state a blade is located between the light illumination device and the optical image acquisition device.

Here, the light illumination device may illuminate a measurement target with variable illumination and temperature in consideration of an intensity of illumination around a measurement point.

Here, the image analysis and erosion amount calculation device may distinguish a measurement region from a non-measurement region according to whether the light is covered by a blade and analyze an erosion amount in a measurement region.

Here, the image analysis and erosion amount calculation device may distinguish a measurement region from a non-measurement region from an acquired image using a difference in respective brightnesses, and may be capable of variably setting a distinguishable criterion between 100 and 255.

Here, the image analysis and erosion amount calculation device may distinguish a target measurement region from a non-target measurement region based on a distinguishable criterion according to a brightness, and analyze a successive location information of an outermost edge line of a target blade to be measured.

Here, the image analysis and erosion amount calculation device may include, in the image, virtual vertical lines perpendicular to a blade length direction at a plurality of locations to be measured along a blade length direction, and measure a blade width by locations with a distance between the two intersection points where the vertical lines meet the outermost edge line of a blade.

Here, the image analysis and erosion amount calculation device may calculate an area-based erosion amount of a blade by integrating each blade width information measured at equal intervals along a length direction of a blade.

Another embodiment is an erosion measurement system for a turbine blade, including: a blade boundary identification device for determining a boundary of a single blade region for a turbine blade inspection; an optical image acquisition device for creating an image optically photographing a blade surface; an image analysis and erosion amount calculation device for analyzing an image photographed by the optical image acquisition device and calculating an erosion amount of a blade,

and the light illumination device and the optical image acquisition device may be fixed to face each other with a target blade disposed at a center and photographing the target blade while moving relatively in a circumferential direction of a turbine, and the image analysis and erosion amount calculation device may calculate an erosion amount in a manner accumulating an erosion amount at a plurality of measurement locations disposed inside a blade.

Here, the blade boundary identification device may include: a light illumination device for irradiating light to a turbine blade; and an optical sensor for recognizing an intensity of light reflected from a surface of a blade.

Here, the erosion measurement system for a turbine blade may further include: a turbine rotation means for rotating a turbine with a blade located between the blade boundary identification device and the optical image acquisition device.

### Advantageous Effects

The erosion measurement system for a turbine blade according to the present disclosure having the above-described configuration has an advantage of securing the operational reliability of turbines of a power plant by precisely and quickly measuring the erosion amount of turbine blades of a power plant.

### DESCRIPTION OF DRAWINGS

FIG. 1 are photos illustrating cases of damage to turbine blades caused by water droplet erosion.

FIG. 2a is a conceptual diagram illustrating a functional configuration according to an embodiment of an erosion measurement system for a turbine blade according to the spirit of the present disclosure.

FIG. 2b is a conceptual diagram illustrating the principle of distinguishing a measurement region of a blade and measuring a blade width.

FIG. 3 is a screen showing a result of calculating an erosion amount to which the spirit of the present disclosure is applied.

FIG. 4 is a conceptual diagram illustrating an erosion measurement system for a turbine blade according to another embodiment for overcoming the above-described second problem.

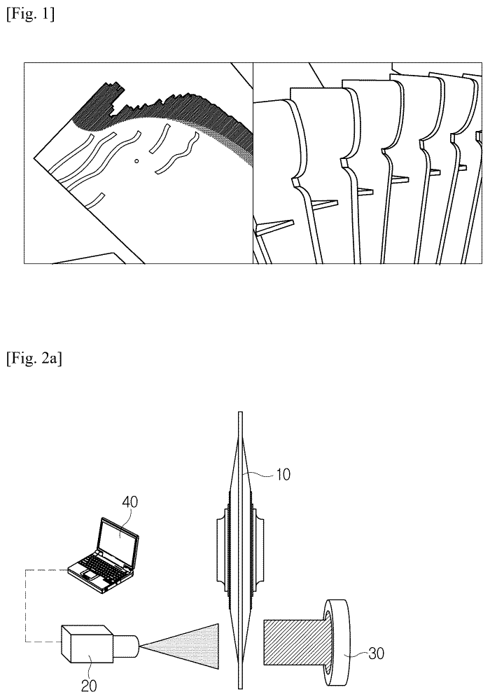

### REFERENCE NUMERALS

10: TURBINE BLADE
20, 120: OPTICAL IMAGE ACQUISITION DEVICE
30, 133: LIGHT ILLUMINATION DEVICE
40, 140: IMAGE ANALYSIS AND EROSION AMOUNT CALCULATION DEVICE
135: OPTICAL SENSOR
170: U-SHAPED SUPPORT FRAME
180: TURBINE ROTATION MEANS

### MODE FOR INVENTION

Terms used in the specification, ‘first’, ‘second’, etc. can be used to describe various components, but the components are not to be construed as being limited to the terms. The terms are only used to differentiate one component from other components. For example, the ‘first’ component may be named the ‘second’ component without departing from the scope of the present disclosure, and the ‘second’ component may also be similarly named the ‘first’component.

When an arbitrary component is described as “being connected to ”or“ being linked to” another component, this should be understood to mean that still another component(s) may exist between them, although the arbitrary component may be directly connected to, or linked to, the second component.

The terms used in the present application are used to describe only specific embodiments or examples, and are not intended to limit the present disclosure. A singular expression can include a plural expression as long as it does not have an apparently different meaning in context.

It should be understood that terms such as ‘comprise’, or ‘have’ and the like are used only to designate that there are features, numbers, steps, operations, components, parts or combination thereof, however such terms do not preclude existence or addition of one or more another features, numbers, steps, operations, components, parts or combination thereof.

In addition, shapes and sizes of elements shown in the drawings may be exaggerated for clarity.

In the present disclosure, an optical image acquisition device such as a vision camera is applied to collectively measure an amount of erosion on a surface of a turbine blade 1 instead of applying a surface roughness meter or laser which have been conventionally used to measure the erosion amount on a surface of the turbine blade 1.

Then, by doing so, the measurable pixel of the corresponding optical image acquisition device can be adjusted and erosion amount resolution can be adjusted variably from tens to hundreds of micrometers. By applying this method, it will be possible to change the system so that accurate measurement and collective record management of location information where the erosion amount is measured can be performed.

However, when applying the optical image acquisition analysis method to turbine blades having a relatively complex shape, the following difficulties occur.

First, there may be a plurality of turbines provided in one generator, and each turbine has dozens to hundreds of blades, so a general photographic analysis method increases the complexity of image processing and cannot secure sufficient work speed.

Second, in most cases, each blade formed on each turbine overlaps a neighboring blade. In this case, a part of one blade is covered by another blade in a captured image, thus it is difficult to determine an exact region (area or width) of a target blade.

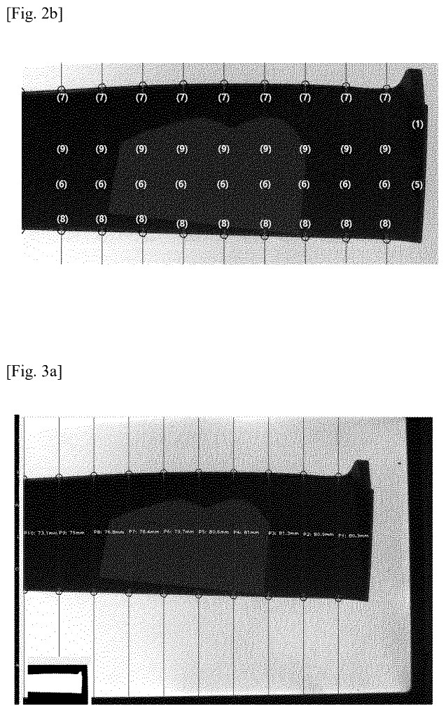

FIG. 2a is a conceptual diagram illustrating a functional configuration according to an embodiment of an erosion measurement system for a turbine blade according to the spirit of the present disclosure, and FIG. 2b is a conceptual diagram illustrating the principle of distinguishing a measurement region of a blade and measuring a blade width.

An erosion measurement system for a turbine blade illustrated in the drawings may include: a light illumination device 30 for irradiating light to generate a brightness difference to distinguish a measurement region when inspecting a turbine blade 10; an optical image acquisition device 20 for creating an image optically photographing a blade surface; and an image analysis and erosion amount calculation device 40 for analyzing an image photographed by the optical image acquisition device 20 and calculating an erosion amount of a blade.

Here, the light illumination device 30 and the optical image acquisition device 20 are fixed to face each other with a target blade disposed at a center and photographing a target blade while moving relatively in a circumferential direction of a turbine 10, and the image analysis and erosion amount calculation device 40 calculates an erosion amount in a manner accumulating an erosion amount at a plurality of measurement locations located inside a blade.

The erosion measurement system for a turbine blade is intended to overcome the above described first difficulty, by placing a target blade between the light illumination device 30 and the optical image acquisition device 20 whose positions are fixed to each other, and photographing the target blades while rotating the turbine 10 of the blade, or moving the light illumination device 30 and the optical image acquisition device 20, the positions of which are fixed to each other, and the erosion measurement system for a turbine blade can sequentially measure, diagnose and measure the turbine blades arranged in a circumferential direction. In such a method, it is possible to diagnose a large number of blades at once.

In order to increase the accuracy of diagnosis and measurement, even when photographing of one blade is repeated, a method of photographing a target blade returned to a photographing location when the turbine 10 rotates once may be applied.

In order for a relative movement in a circumferential direction of the turbine 10 of the target blade by the light illumination device 30 and the optical image acquisition device 20, the light illumination device 30 and the optical image acquisition device 20 may be fixed by a certain frame (e.g., a U-shaped support frame in which a light illumination device and an optical image acquisition device are respectively installed at both ends) and the erosion measurement system for a turbine may further include: a turbine rotation means (not illustrated) for rotating the turbine 10 in a state the blade is located between the light illumination device 30 and the optical image acquisition device 20.

The light illumination device 30 according to the improved implementation may illuminate a measurement target with variable illumination and temperature in consideration of an intensity of illumination around a measurement point.

The erosion amount calculation device 40 may distinguish a measurement region from a non-measurement region using a brightness difference according to whether the light is covered by the blade in an acquired image photographed by the optical image acquisition device 20, and measure the erosion amount in the measurement region.

To describe the processes for this in detail, when an image is acquired by irradiating high-intensity light by the light illumination device 30 toward a target blade to be measured, and placing the optical image acquisition device 20 on an opposite side of the lighting illumination device, due to a shadow caused by the light, an image where the target blade to be measured is distinguished by having a low brightness close to black, and an area where no blade exists is distinguished by having a low brightness close to white by the light is acquired. The difference in a brightness between the target measurement region and the non-target measurement region appeared in this way serves as an identifier that can very precisely distinguish shapes of all regions of the target blade to be measured from the acquired image. Information on an outermost edge line ((5) in FIG. 2b) of the blade can be acquired through the identifier.

In addition, if a user sets a plurality of locations to be measured in a length direction (radial direction) of the blade, and inserts, at each location, an arbitrary virtual vertical vector line ((6) in FIG. 2b) perpendicular to a radius vector into the image to be measured, location information on an upper outermost intersection point ((7) in FIG. 2b) and a lower outermost intersection point ((8) in FIG. 2b) where the corresponding vertical lines meet the upper outermost edge line and the lower outermost edge line of the blade can be calculated, and by calculating a distance between the upper intersection point and the lower intersection point, a blade width ((9) in FIG. 2b) at the corresponding location to measure erosion can be found.

A blade width at each measurement location measured in this way is a value representing the current state of the blade, and when the value is compared with a width at each location of the initial blade (a blade without erosion), an amount of blade erosion at each location can be found.

To summarize the above processes, the image analysis and erosion amount calculation device may distinguish a target measurement region from a non-target measurement region based on a distinguishable criterion according to a brightness, and analyze a successive location information of an outermost edge line of a target blade to be measured.

Based on the above processes, the image analysis and erosion amount calculation device 40 may include, in the image, virtual vertical lines perpendicular to a blade length direction at a plurality of locations to be measured along a blade length direction, and measure a blade width by locations with a distance between the two intersection points where the vertical lines meet the outermost edge line of the blade.

Lastly, the image analysis and erosion amount calculation device 40 may calculate an area-based erosion amount of the blade by integrating each blade width information measured at equal intervals along a length direction of the blade.

In addition, the image analysis and erosion amount calculation device 40 may distinguish the measurement region from the non-measurement region from an acquired image using a respective brightness difference, and be capable of variably setting a distinguishable criterion between 100 and 255.

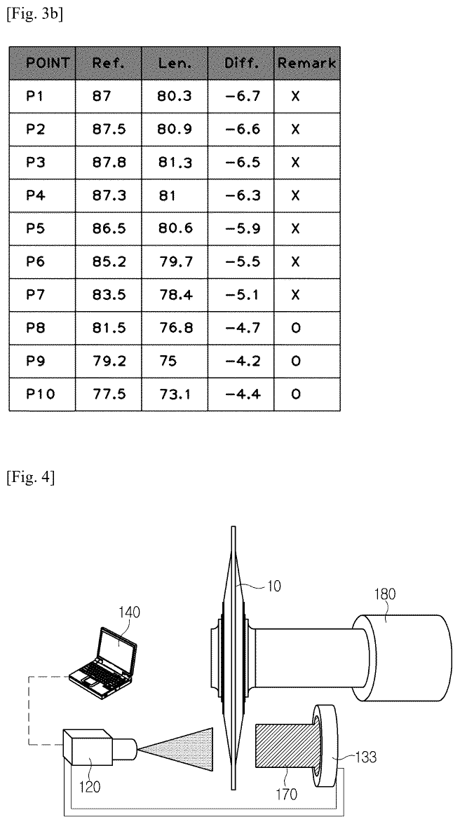

FIG. 3 is a screen showing a result of calculating an erosion amount to which the spirit of the present disclosure is applied.

An example of configuring the erosion measurement system for a turbine blade through an optical image analysis based on the above description is shown in FIG. 3. The illumination intensity and temperature of the light illumination device are set in consideration of the surrounding lighting environment at an outside of the target blade to be measured, and the optical image acquisition device acquires an image including the light source portion of the lighting illumination device together with the target blade.

In the acquired image, there is a contrast difference between the measurement region and the non-measurement region due to shadow generation by the lighting, and by adjusting the contrast more clearly through image post-processing, as shown in FIG. 3, the outermost edge line of the target blade to be measured can be clearly specified.

In the illustrated example of erosion amount calculation, 10 locations to measure erosion are designated in the length direction of the blade to help visual understanding, and after adding a virtual vertical vector to the image at each location, information on the blade width was calculated. In addition, at each location, the erosion amount of the current blade can be confirmed by comparing width information of a new product with width information of the current blade, and whether it is available to use the blade in the current state can be determined by comparing the information with a predetermined reference value set by the user. In addition, it is easy to increase the number of measurement locations easily according to the user's needs, and by sufficiently increasing the number of the measurement locations, it is possible to provide users with information on the erosion amount in the form of an area as well as information on the erosion amount in the form of a length through integration of each length.

Next, the erosion measurement system for a turbine blade for overcoming the second difficulty described above, that is, the difficulty in recognizing blades due to the overlapping of each blade formed in each turbine with a neighboring blade, will be described.

FIG. 4 is a conceptual diagram illustrating an erosion measurement system for a turbine blade according to another embodiment for overcoming the above-described second problem.

The erosion measurement system for a turbine blade, as illustrated in FIG. 4, includes: a blade boundary identification devices 133 and 135 to determine a boundary of a single blade region for a turbine blade 10 inspection; an optical image acquisition device 120 for creating an image optically photographing a blade surface; an image analysis and erosion amount calculation device 140 for analyzing an image photographed by the optical image acquisition device 120 and calculating an erosion amount of a blade, and the light illumination devices 133 and 135 and the optical image acquisition device 120 are fixed to face each other with the target blade disposed at a center and photographing the target blade while moving relatively in a circumferential direction of the turbine, and the image analysis and erosion amount calculation device 140 calculates an erosion amount in a manner accumulating an erosion amount at a plurality of measurement locations located inside a blade.

The blade boundary identification device may be implemented to be various devices capable of identifying regions where blades overlap each other, such as a laser irradiation apparatus, a laser receiving apparatus and the like.

Among others, in the case of implementing the blade boundary identification devices 133 and 135 as a light illumination device 133 for irradiating light to the turbine blade; and an optical sensor 135 for recognizing an intensity of light reflected from a surface of the blade, as in the embodiment of FIG. 2, it is preferable to simultaneously achieve an advantage of clearly and quickly distinguishing the target measurement region from the non-target measurement region and an advantage of overcoming the above described second difficulty through the difference in a brightness.

In this case, a portion where the optical detection value of the optical sensor 135 rapidly fluctuates may be recognized as a boundary of a single blade region.

In FIG. 2b, an upper edge is a portion where erosion occurs, and a lower edge is a portion where erosion hardly occurs. In the case of photographing only one side of the turbine, due to mutual overlap between dense blades, it is impossible to photograph both the ‘upper edge’ and the ‘lower edge’ since only one must be selectively photographed, and accordingly, the optical image acquisition device 120 is disposed to photograph the ‘upper edge’ where erosion occurs.

Accordingly, in FIG. 2b, though the dots 1094, 1101, 1106, 1112, . . . , 1146 and a line connecting these dots are not distinguished from the image photographed by the optical image acquisition device 120 because the dots are covered by the adjacent blades, the light illumination devices 133 and 135 disposed opposite the optical image acquisition device identify the line connecting the dots, and the image analysis and erosion amount calculation device 140 may perform analysis by specifying the dots belonging to the lines identified by the boundary identification device 133 and 135 as starting points with respect to the blade width.

The illustrated erosion measurement system for a turbine blade includes a U-shaped support frame in which the light illumination device 120 and the optical image acquisition devices 133 and 135 are respectively installed at both ends to fix the locations of the boundary identification devices 133 and 135 and the light illumination device 120; and a turbine rotation means 180 for rotating a turbine with a blade located between the blade boundary identification devices 133 and 135 and the optical image acquisition device 120.

Those skilled in the art will appreciate that since various modifications and alterations may be made without departing from the spirit or essential feature of the present disclosure, the above-mentioned embodiments are not restrictive but are exemplary in all aspects. It should be interpreted that the scope of the present invention is defined by the following claims rather than the above-mentioned detailed description and all modifications or alterations deduced from the meaning, the scope, and equivalences of the claims are included in the scope of the present disclosure.

### Industrial Applicability

The present invention can be applied to accurately remotely monitor/diagnose turbine blades on-site.

What is claimed is:

1. An erosion measurement system for a turbine blade, comprising:
a light illumination device for irradiating light to generate a brightness difference to distinguish a measurement region when inspecting a turbine blade;
an optical image acquisition device for creating an image optically photographing a blade surface; and
an image analysis and erosion amount calculation device for analyzing an image photographed by the optical image acquisition device and calculating an erosion amount of a blade,
wherein the light illumination device and the optical image acquisition device are fixed to face each other with a target blade disposed at a center and photographing a target blade while moving relatively in a circumferential direction of a turbine, and
the image analysis and erosion amount calculation device calculates an erosion amount in a manner accumulating an erosion amount at a plurality of measurement locations located inside a blade.

2. The erosion measurement system for a turbine blade of claim 1, further comprising:
a turbine rotation means for rotating a turbine in a state a blade is located between the light illumination device and the optical image acquisition device.

3. The erosion measurement system for a turbine blade of claim 1,
wherein the light illumination device illuminates a measurement target with variable illumination and temperature in consideration of an intensity of illumination around a measurement point.

4. The erosion measurement system for a turbine blade of claim 1,
wherein the image analysis and erosion amount calculation device distinguishes a measurement region from a non-measurement region according to whether the light is covered by a blade and analyzes an erosion amount in a measurement region.

5. The erosion measurement system for a turbine blade of claim 4,
wherein the image analysis and erosion amount calculation device distinguishes a measurement region from a non-measurement region from an acquired image using a difference in respective brightnesses, and is capable of variably setting a distinguishable criterion between 100 and 255.

6. The erosion measurement system for a turbine blade of claim 4,
wherein the image analysis and erosion amount calculation device distinguishes a target measurement region from a non-target measurement region based on a distinguishable criterion according to a brightness, and analyzes a successive location information of an outermost edge line of a target blade to be measured.

7. The erosion measurement system for a turbine blade of claim 6,
wherein the image analysis and erosion amount calculation device includes, in the image, virtual vertical lines perpendicular to a blade length direction at a plurality of locations to be measured along a blade length direction, and measures a blade width by locations with a distance between the two intersection points where the vertical lines meet the outermost edge line of a blade.

8. The erosion measurement system for a turbine blade of claim 7,
wherein the image analysis and erosion amount calculation device calculates an area-based erosion amount of a blade by integrating each blade width information measured at equal intervals along a length direction of a blade.

9. An erosion measurement system for a turbine blade, comprising:
a blade boundary identification device for determining a boundary of a single blade region for a turbine blade inspection;
an optical image acquisition device for creating an image optically photographing a blade surface;
an image analysis and erosion amount calculation device for analyzing an image photographed by the optical image acquisition device and calculating an erosion amount of a blade,
wherein the light illumination device and the optical image acquisition device are fixed to face each other with a target blade disposed at a center and photographing the target blade while moving relatively in a circumferential direction of a turbine, and
the image analysis and erosion amount calculation device calculates an erosion amount in a manner accumulating an erosion amount at a plurality of measurement locations disposed inside a blade.

10. The erosion measurement system for a turbine blade of claim 9,
wherein the blade boundary identification device comprises:
a light illumination device for irradiating light to a turbine blade; and
an optical sensor for recognizing an intensity of light reflected from a surface of a blade.

11. The erosion measurement system for a turbine blade of claim 9, further comprising:
a turbine rotation means for rotating a turbine with a blade located between the blade boundary identification device and the optical image acquisition device.
